(19) United States
(12) Patent Application Publication
(10) Pub. No.: US 2011/0240507 A1
(43) Pub. Date: Oct. 6, 2011

(54) WATER TANK IMPROVEMENTS

(76) Inventor: Peter John Snelling, West Lakes (AU)

(21) Appl. No.: 12/753,428

(22) Filed: Apr. 2, 2010

(51) Int. Cl. B65D 81/02; B29C 41/08

(52) U.S. Cl. 206/521; 264/309

(57) ABSTRACT

A thin tank integrally molded by rotational molding of plastics material with a plurality of laterally extending channels with interconnecting ties between correspondingly positioned channels. End channels are inset into each end wall to provide interlocking engagement with a support post or bracket.

### TECHNICAL FIELD

This invention relates to a water tank and in particular to one formed from plastics material and is dimensioned so that it can be generally described as a “thin” tank.

### BACKGROUND OF THE INVENTION

With the current prospect of global warming and fears of increasing lack of potable water, water tanks that can be located in some more difficult locations is desirable.

This is particularly the case with a tank that has a relatively small width so that it can be located in places where space is very limited or in places where it is convenient to have a relatively thin barrier as for instance in a fencing application.

One of the difficulties with tanks in general is that in order to store a reasonable quantity of water, they will need to have a relatively deep storage area and the difficulty here is that this will cause relatively high pressures at and toward the bottom of the tank when filled with water due simply to the head of water within the tank.

Another and perhaps more significant problem relates to appearance.

One known example of a thin tank comprised of a plastics wall, has external metal bracing across its broad face in order to have the plastic walls retained without distortion against any reasonable head of water in the tank.

External bracing implicitly contributes significant mechanical parts to the visual appearance and to many people is undesirable purely from an appearance point of view. Internal bracing at first sight is not an option because of the narrowness between the broad sides which limits access at least for subsequent installation.

Further however, in order to achieve adequate bracing strength, the elements providing such bracing must be substantial and any plastic wall in order to accommodate such bracing has either to be moulded to allow for a substantial insetting of such reinforcing members or, if they are positioned to extend proud of a side wall, then these can add significantly to the overall width of such a tank and can thereby implicitly destroy or at least reduce its advantage of being thin and still hold a reasonable quantity of water.

### SUMMARY OF THE INVENTION

An object of this invention then is to propose a tank comprised of plastics material which at least provides some assistance in respect of such difficulties.

According to this invention then, there is provided a thin tank comprised of an integrally moulded plastics material tank having two sides each approximately planar and aligned to be parallel one to the other, an end wall at each respective end of the sides and a top wall and a bottom wall joining respectively a top edge of the sides and a bottom edge of the sides to provide therebetween a water holding space, and a plurality of laterally extending vertically spaced apart embedded reinforcing channels which are formed in each side wall the channels being positioned in opposedly correspondingly located locations in the respective side walls of the tank.

Thus, in one embodiment, this invention provides a thin tank comprised of an integrally moulded plastics material tank having a first side wall and a second side wall, said first and second side walls being approximately planar and aligned with each other to be parallel one to the other, a left end wall at a left end of said first and second side walls, a right end wall at a right end of said first and second sidewalls, and a top wall and a bottom wall joining respectively a top edge of said first and second side walls and a bottom edge of said first and second side walls to provide therebetween a water holding space, and a plurality of reinforcing channels formed in and extending laterally across each said first and second side wall, said reinforcing channels being vertically spaced apart, wherein each said reinforcing channel in said first sidewall is aligned with a reinforcing channel in said second sidewall

The inset channels can be relatively straightforwardly moulded from plastic by using for instance a rotational moulding technique and by having such channels moulded at spaced apart intervals in a vertical spaced alignment. The spacing can be selected and the depth of the channel selected to accord with the head height and length of a tank which can then be chosen in accordance with a desirable storage capacity. It has been discovered that if one uses this technique, some advantage can be obtained by increasing the vertical spacing of the laterally extending reinforcing channels at an upper part of the tank as compared to a lower part of the tank. This is because the burst pressure of a head of water is directly proportional to the depth of water.

This allows the length of a tank to be chosen to allow for sufficient strength in line with head height but not having to suffer undue interruptions within a visual appearance.

It becomes extremely difficult with a very thin tank and by thin we mean in the range of 200 to 300 mm width which is to say the maximum distance apart of the respective side walls, although it is not intended that such a width be a limiting range at this stage, that it is difficult to provide internal ties or bracing. This is not a problem if you have external bracing but there is a visual price to be paid with external bracing.

In other embodiments the tank is further comprised in that at each end of the tank there is a channel extending from a bottom to the top of each end wall. When two tanks are placed side-to-side, these channels mate such that it is possible for a post to be inserted into the through bore defined by the mated channels, and the posts can be held independently of the tanks, for instance embedded in the ground or otherwise supported to support the tanks.

In simple terms then, by having means to effect embedding of vertical posts at each end, there can be presented a continuous face on each side of a tank line where there might be two or more such tanks abutting one against the other with of course a post nesting and holding the relative adjoining ends.

In the event that the tank is located to lie against a wall then use of a bracket with one at preferably both ends of the tank allows a portion of the bracket to interlock with the channel and a further portion can then be attached to the wall. This can also apply to two abutted tanks where the bracket then has a portion that interlocks with both adjacent channels of two tanks while a further portion is attached to the wall or of course other support structure.

In a next improvement, there is moulded between oppositely positioned channels, an interconnecting link whereby there is during the moulding process a member passing from one side of an expected channel position to another and there is moulded thereby around such a member and integrating with the channels therein, such a form which thereby acts as an internal bracing between the respective sides.

In preference, there is at least one of these ties but in practical terms one would expect that these can be distributed throughout these channels so there might be for instance three, four or more of these between each respective oppositely positioned channels.

A further advantage in relation to shaping a wall which now has a plurality of segments which are extending horizontally, is that the external wall is arcuate in cross section and is of a consistent arcuate shape throughout its length.

This has the advantage that it does implicitly stiffen the wall segment thus shaped but it also relieves the view of seeing a perfectly planar surface where any bulging will be much more apparent than if there is in effect a slight bulging on a controlled basis where a little more bulging will not be so apparent.

### DESCRIPTION OF THE DRAWINGS

For a better understanding of this invention it will now with reference to an embodiment which will be described with the assistance of drawings wherein,

FIG. 1 is a perspective view of the tank according to the first embodiment,

FIG. 2 is a further perspective view of the same tank viewed from slightly below the tank,

FIG. 3 is a cross sectional view through the tank,

FIG. 4 illustrates two tanks joined together,

FIG. 5 illustrates two tanks where the separate parts including posts are separated, and

FIG. 6 is an assembly illustrating the details of a combination of two tanks supported by inverted posts,

FIG. 7 is a cross sectional view of an end portion of a tank with a further fitting according to a second embodiment,

FIG. 8 is an end elevation of the tank as in FIG. 7, and

FIG. 9 is a cross sectional view of a further embodiment using a bracket attached to a wall where there are two abutted tanks jointly held by having the bracket interlock within each respective end channel.

### DETAILED DESCRIPTION OF THE INVENTION

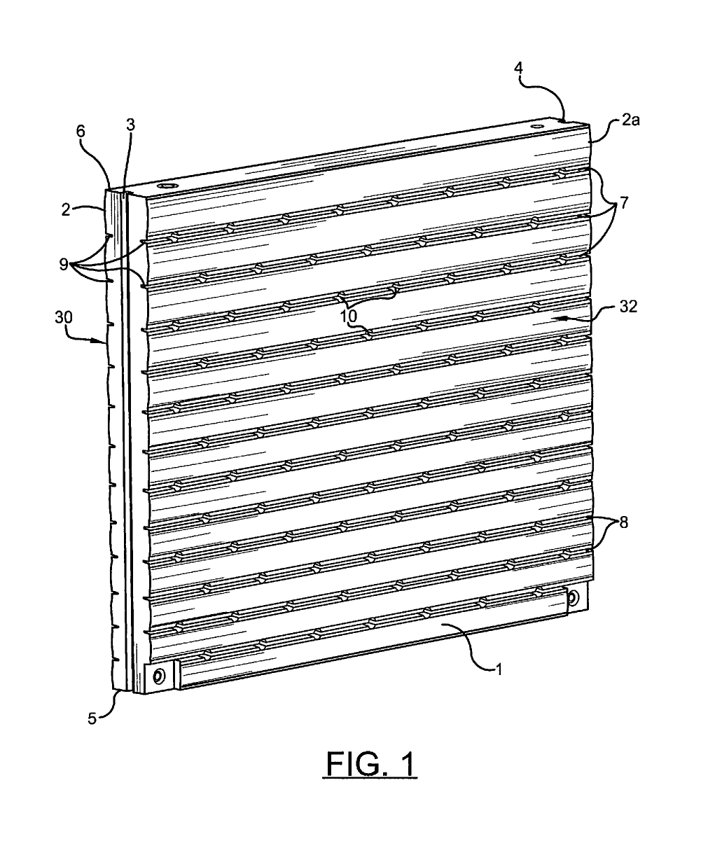

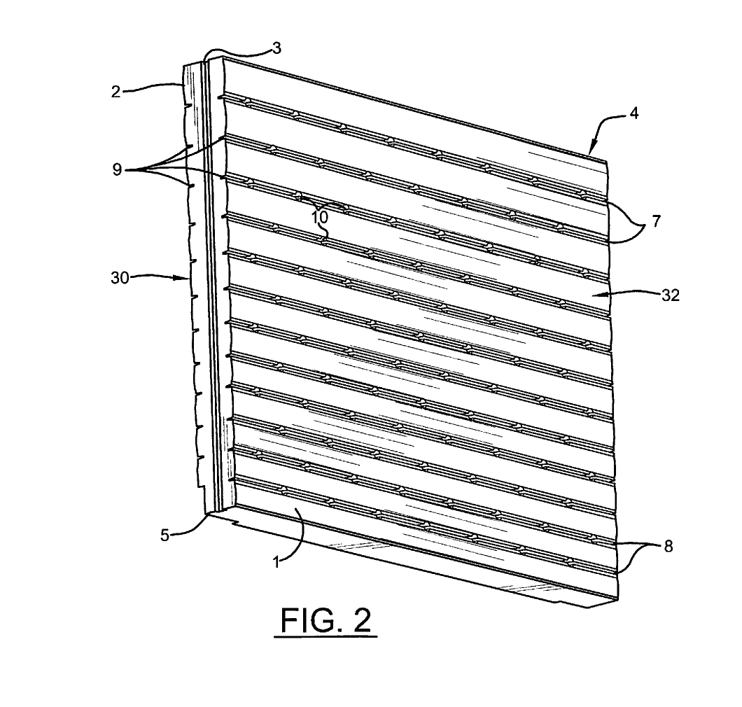

Referring specifically to the drawings FIGS. 1 through 6, a particular, non-limiting embodiment of a tank 1 in accordance with this invention is moulded by rotational moulding and has dimensions where the width, which is to say the maximum distance apart of the first side wall 30 and second side wall 32, is 230 millimeters (mm), the height is 1850 mm and the length is 2400 mm. These dimensions provide capacity in the tank for close to 1000 litres of water.

While this invention is not to be limited to or by and particular dimensions, the width is preferably kept small, between 200 and 300 mm, and, in other embodiments, is below 250 mm.

Each tank has an embedded channel 3 at one end 2, and an embedded channel 4 at the opposite end 2a, each embedded channel 3 and 4 extending fully from a bottom wall 5 of the tank to a top wall 6 of the tank. The ends 2 and 2a may be considered as left and right end walls.

Extending laterally between the ends 2 and 2a of the tank, are a plurality of reinforcing channels 7 extending along on both sides of the tank and embedded within the wall of the tank so as to provide a rigid reinforcing shape.

In accordance with the vertical spacing, the neighboring reinforcing channels 7 near the bottom of the tank 1, as identified at the numeral 8, are spaced closer together than those neighboring channels 7 nearer the top of the tank 1, as identified at 9, to allow for a variation in the head pressure that the tank must resist

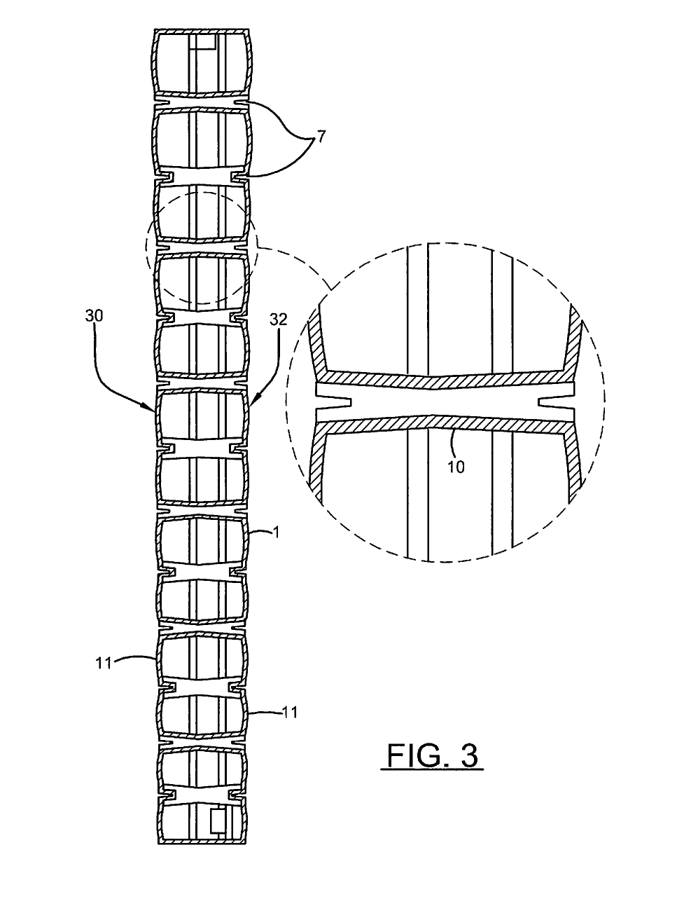

A further feature of the tank is that between oppositely positioned channels in respective sides of the tank there is a moulded bracing shown most clearly at 10 in FIG. 3, where there is moulded a conduit from one side to the other but which then provides connecting walls between respective reinforcing channels 7. This is achieved by having mold members placed in position around which the plastic is molded and then as appropriate this is removed but leaving a hollow tubular conduit which none the less acts as an internal bracing. This internal bracing is also termed herein “interconnecting tie(s).”

A further feature is that the portions of the first side wall 30 and second side wall 32 extending between each reinforcing channel 7 are arcuate and are of a constant arcuate shape along those portions, as generally shown at the numeral 11. They are outwardly arcuate shape such that they are of slightly bulbus or convex shape when viewed from outside. Preferably, the shape is consistent along the length of the tank. This provides further stiffening and gives a purposeful bulbus shape that visually reduces the sensitivity of planar surfaces showing even slight bulbus distortion.

By using these techniques, an external face which presents as generally a large generally planar area can have all of this stiffening without being visually distasteful.

Further however, the length of each tank can now be chosen in accordance with the ability to strengthen and stiffen the side walls and any number of such tanks can now be joined one to another where the supporting post between them can be hidden.

This then makes them ideal for applications such as providing fencing panels or for being located as a barrier or shield.

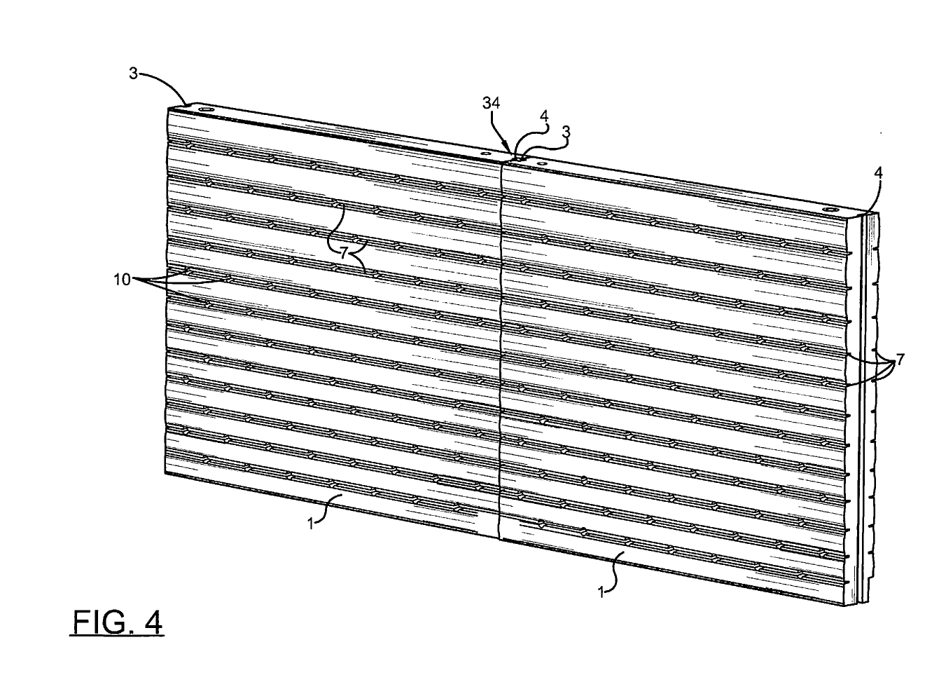

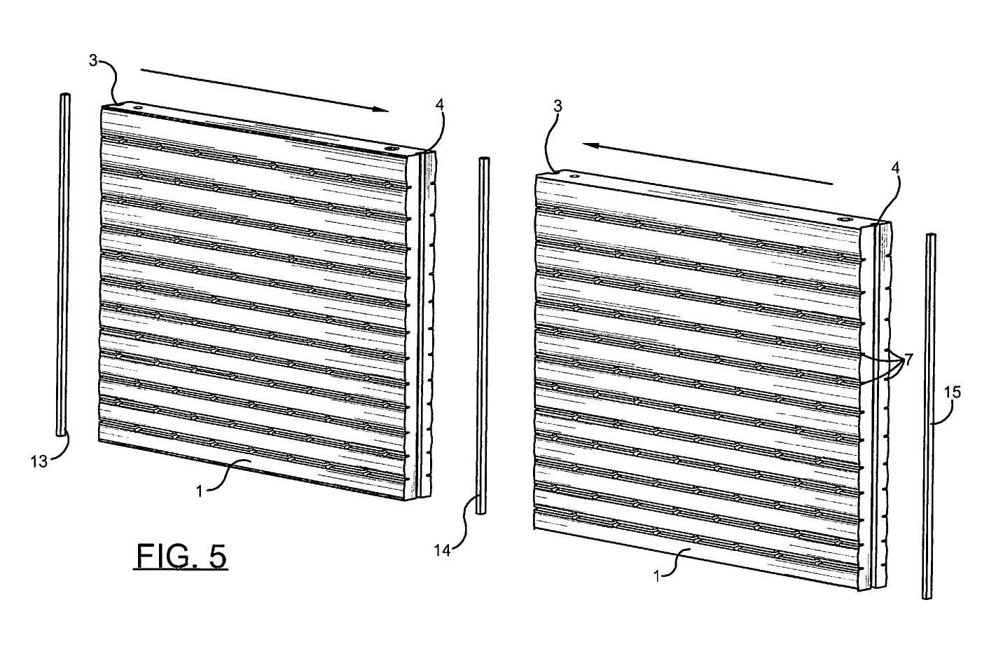

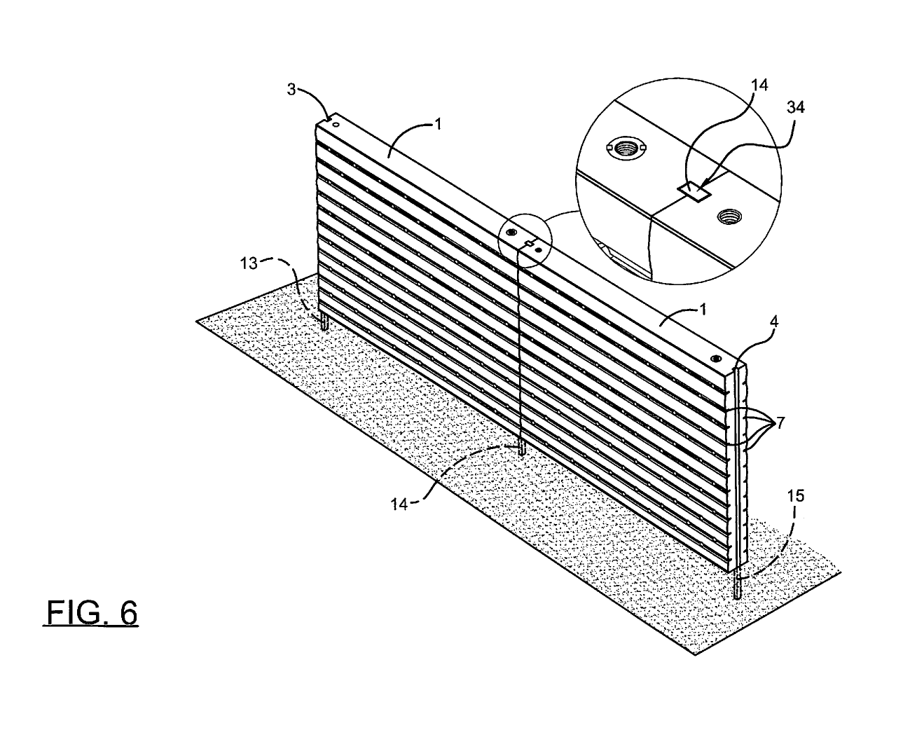

These applications are more apparent when the further illustrations are seen. For instance, in FIGS. 4-6, the posts 13, 14 and 15 are embedded in mating channels (such as embedded channels 3 and 4, shown mated in FIGS. 5 and 6) so that visually they are not prominent and the visually external appearance is generally of a planar barrier while usefully large quantities of water can be stored in these relatively thin tanks. Each embedded channel (3 or 4) is shaped to provide an external cross section that, when mated to the other embedded channel (as in FIG. 6) presents a through bore 34 for receiving a post (such as 13, 14, or 15).

Interconnections between the tanks are of course according to standard techniques and do not need to be described in detail here.

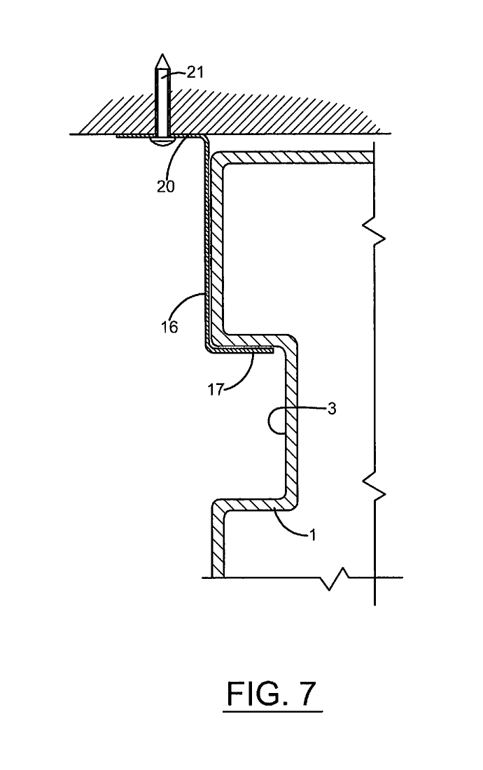

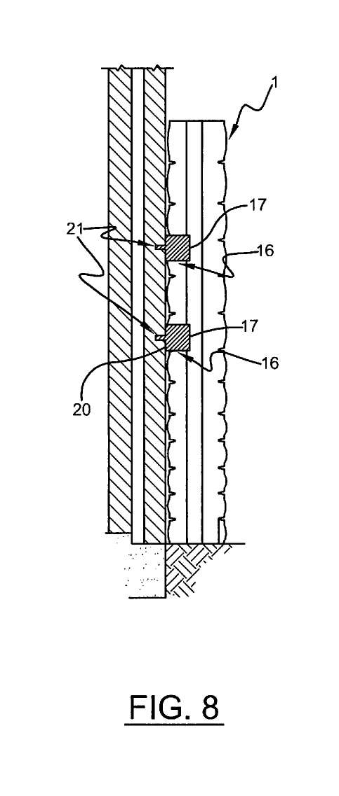

Now referring to FIGS. 7 and 8, there is a bracket 16 having a portion 17 interlocking with an embedded channel 3 of a tank 1. A further portion 20 of the bracket 16 is attached to a wall by masonry bolts shown typically at 21.

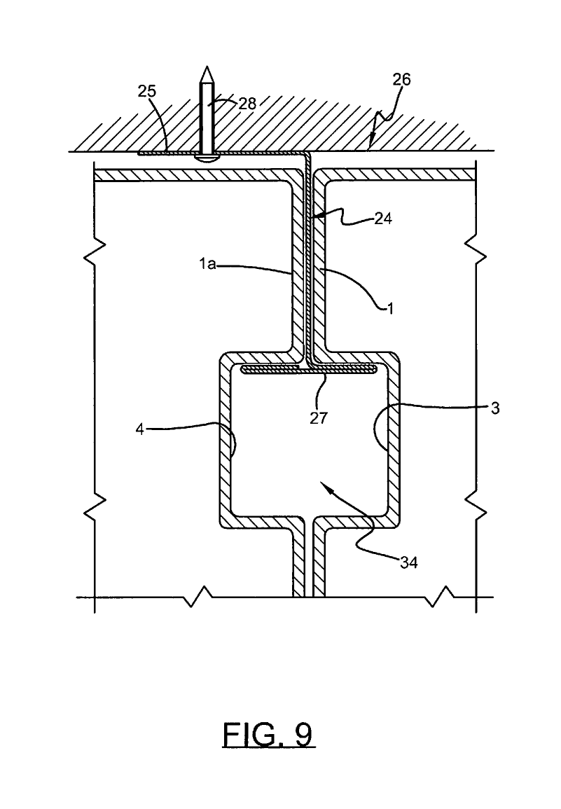

In a further example as in FIG. 9, there are two tanks 1 and 1a which are abutted together with a bracket 24 attached at one portion 25 to a wall 26 by masonry bolts 28 and at a further end a portion 27 extends into the through bore 34 created by the mating of both embedded channels 3 and 4, as already described. This bracket 24 holds the tanks 1 and 1a together with imperceptible visual disruption.

The tanks in accordance with this invention can be formed by rotomolding. First, a mold cavity is created to define the first side wall, the second side wall, the left end wall, the right end wall, the top wall, the bottom wall and the plurality of channels in said first and second side walls extending from said left end wall to said right end wall. This generally defines a mold material holding space. A plurality of mold member are positioned the mold cavity to extend from a channel in a first side wall to a channel in the second side wall at spaced locations along the length of the channels. Mold material is added to the mold cavity, which is heated to melt the mold material and permit it to flow during rotation of the mold cavity. The mold cavity is rotated to disperse the mold material about the interior of the mold cavity, and the mold cavity is then cooled to permit the mold material to set, the setting of the mold material creating a thin tank with a plurality internal bracing members formed where the mold members were positioned in said mold cavity. The mold members are preferably removed after molding.

1. A thin tank comprised of an integrally moulded plastics material tank having a first side wall and a second side wall, said first and second side walls being approximately planar and aligned with each other to be parallel one to the other, a left end wall at a left end of said first and second side walls, a right end wall at a right end of said first and second sidewalls, and a top wall and a bottom wall joining respectively a top edge of said first and second side walls and a bottom edge of said first and second side walls to provide therebetween a water holding space, and a plurality of reinforcing channels formed in and extending laterally across each said first and second side wall, said reinforcing channels being vertically spaced apart, wherein each said reinforcing channel in said first sidewall is aligned with a reinforcing channel in said second sidewall.

2. A thin tank as in claim 1 further comprising a left channel in said left end wall extending from a bottom to the top of said left end wall.

3. A thin tank as in claim 2 further comprising a right channel in said right end wall extending from a bottom to the top of said right end wall.

4. A thin tank as in claim 1 wherein at least two neighboring channels of said plurality of reinforcing channels at an upper part of the tank are further apart than at least two neighboring channels of said plurality of reinforcing channels at a lower part of the tank.

5. A thin tank as in claim 1 further comprising at least one interconnecting tie moulded integrally between a reinforcing channel in said first sidewall and an aligned reinforcing channel in said second side wall.

6. A thin tank as in claim 4 further comprising a plurality of interconnecting ties, each of said plurality of interconnecting ties being positioned between a reinforcing channel in said first sidewall and an aligned reinforcing channel in said second side wall, wherein there exists at least one interconnecting tie between each set of aligned reinforcing channels.

7. A thin tank as in preceding claim 1 further comprised in that the portion of said first side wall extending between each said reinforcing channel is arcuate and is of a constant arcuate shape along that portion thereof.

8. A thin tank as in preceding claim 7 further comprised in that the portion of said second side wall extending between each said reinforcing channel is arcuate and is of a constant arcuate shape along that portion.

9. A thin tank as in claim 1 where the tank is manufactured by rotational moulding.

10. A thin tank as in preceding claim 1 wherein a maximum distance apart of said first and second side walls is less than 250 millimeters.

11. A thin tank as in preceding claim 1 where the tank is integrally molded by rotational molding.

12. A thin tank as in claim 11, wherein during the rotational molding process, a member passing from one side of an expected channel position to another and there is moulded thereby around such a member and integrating with the channels therein, such a form which thereby acts as an internal bracing between the respective sides

13. A method of molding a thin tank comprising the steps of: (1) providing a mold cavity defining (a) a first side wall and (b) a second side wall, the first and second side walls being approximately planar and aligned with each other to be parallel one to the other, (c) a left end wall at a left end of said first and second side walls, (d) a right end wall at a right end of said first and second sidewalls, (e) a top wall, (f) a bottom wall joining respectively a top edge of said first and second side walls and a bottom edge of said first and second side walls, and (g) a plurality of channels in said first and second side walls extending from said left end wall to said right end wall, such that a channel in said first side wall is parallel to a channel is said second end wall, the walls and channels of the cavity as at (a) through (g) above serving to provide therebetween a mold material holding space; (2) positioning a plurality of mold members in said cavity extending from a channel in said first side wall to a channel in said second side wall at spaced locations along the length of the channels; (3) adding mold material to the mold cavity; (4) rotating the mold cavity to disperse the mold material about the interior of the mold cavity; (5) cooling the mold cavity to permit the mold material to set, the setting of the mold material creating a thin tank with a plurality internal bracing members formed where the mold members were positioned in said mold cavity.
